(19) United States
(12) Patent Application Publication
(10) Pub. No.: US 2024/0381892 A1
(43) Pub. Date: Nov. 21, 2024

(54) PROCESS FOR PRODUCING A NON-DAIRY GEL

(71) Applicant: ODDLYGOOD GLOBAL OY, Helsinki (FI)

(72) Inventors: Klaus MUURONEN, Helsinki (FI); Outi MÄKINEN, Helsinki (FI); Kaity-Marin LEHTONEN, Helsinki (FI); Väinö SAARENTOLA, Helsinki (FI)

(21) Appl. No.: 18/254,207

(22) PCT Filed: Nov. 26, 2021
(86) PCT No.: PCT/FI2021/050817

§ 371 Date: May 24, 2023

(30) Foreign Application Priority Data
Dec. 1, 2020 (FI) 20206232

(51) Int. Cl. A23C 20/02; A23J 3/14; A23L 11/40; A23L 11/50; A23L 29/00

(52) U.S. Cl. CPC A23C 20/025; A23J 3/14; A23L 11/40; A23L 11/50; A23L 29/06

(57) ABSTRACT

The present invention concerns the field of food technology. The invention relates to a process for producing a non-dairy protein gel to be used in an edible plant-based food product, especially in non-dairy cheese, which is suitable as a dairy-alternative product, a process for the manufacture thereof and uses related thereto.

### CROSS-REFERENCE TO RELATED APPLICATIONS

This application is a national phase entry under 35 U.S.C. 371 of PCT International Application No. PCT/FI2021/050817 filed Nov. 26, 2021, which claims priority to Finnish Patent Application No. 20206232, filed Dec. 1, 2020, the disclosure of each of these applications is expressly incorporated herein by reference in their entirety.

### FIELD OF THE INVENTION

The present invention concerns the field of food technology. The invention relates to a process for producing a non-dairy protein gel to be used in an edible plant-based food product, especially in non-dairy cheese, which is suitable as a dairy-alternative product, a process for the manufacture thereof and uses related thereto.

### BACKGROUND OF THE INVENTION

Some people need to avoid dairy-based products for reasons, such as lactose intolerance or allergy to milk protein. In addition, the number of consumers who voluntarily prefer a vegetarian or vegan diet is increasing. Plant-based food alternatives are also beneficial from an environmental standpoint because they can help in ensuring a sustainable development by utilizing renewable resources.

Various alternatives to dairy-based products have been introduced on the market and there is an increasing demand for such dairy-alternative or dairy-replacement products, such as plant-based products.

Non-dairy cheeses are typically produced from starches and fat or nut paste and cold-setting polysaccharides, in addition to other components. Also, other ingredients (e.g. flavouring, sugars, stabilisers etc.) and low levels of protein are used. The general process is as follows: mixing the ingredients, heating the mass, and setting of the mass in moulds or final packaging (WO2017150973 A1).

The composition of such starch-based products is not comparable to dairy cheese, that comprises of protein and fat.

In addition to having poor nutritional composition, starch-based cheese replicas lack desired sensory characteristics for cheese-like products, including rubbery mouthfeel and high fracturability/lack of compressibility. Several solutions have been suggested to solve these issues, e.g. increasing the compressibility without rupturing of starch-and fat-based cheese analogue with high acyl gellan (US2020323231 A1), improving texture, taste and nutritional value using potato starch and protein (WO2017150973 A1). WO2020089383 A1 discloses a method of producing “natural” cheese analogue using 0.5-15% non-hydrocolloid dietary fibre, 2-15% plant protein, 0.5-5% calcium salt and 5-30% lipid that are mixed together under high shear, adjusted to pH 4-6 and gelled by cooling. US2010196575 A1 discloses a method for production of cheese replica with at least 50% moisture is manufactured from soy protein hydrolysate solution that is gelled using starch and hydrocolloids.

Another method for producing non-dairy cheese that is widely known and published in various cookbooks and online sources, is setting a nut paste with agar or another gelling polysaccharide. Traditional protein-based bean curds (e.g. tofu and beske) are produced by heating bean milk, coagulating it with salts and pressing the granular curd using cheesecloth or sieve to drain whey.

Production of protein-based non-dairy cheese is possible by gelling the protein with cross-linking enzymes. The resulting non-dairy cheese curd is then processed similarly to dairy cheese: cutting and heating of curd, transferring curd granules to moulds and pressing (EP2731451 B1). A similar process using “plant-origin rennet” has been patented (EP3366144 A1). Because it is challenging to obtain a continuous, strong structure after breaking the curd, the methods described in these patents are better suited for the production of soft cheese replicas, like goat's cheese or ricotta-types. Protein-based cheese replicas made of plant proteins also have unpleasant off-flavours such as beany, cardboard and bitter flavours, that cannot be removed by microbial ripening alone.

In the cheesemaking process, milk is rennet coagulated and the resulting, weak high moisture gel (curd) is cut into small pieces to allow draining of liquid (whey) out of the gel network. When liquid is removed from the gel network, the mechanical strength of the curd increases and enables the application of high pressure, resulting in a strong and elastic structure typical for cheese. Protein based non-dairy cheese can be produced using a similar process (EP2731451 B1) but instead of rennet, the protein is gelled using a cross-linking enzyme.

Dairy cheese is a dynamic, non-covalently cross-linked system, that develops its final structure during ripening. These structural changes include fusion of caseins into thicker fibers and partial fat globule coalescence (Everett, 2007). As a result, curd granules fuse into a solid, elastic structure.

### SUMMARY OF THE INVENTION

The object of the present invention is to overcome problems related to the prior art of producing plant-based dairy-alternative products.

The above-mentioned problems related to the prior art are overcome in the present disclosure. The present disclosure concerns a method for producing non-animal protein-and fat-based cheese replicas that have nutritional composition and texture closer to dairy cheese. The method can be used to produce a wide selection of cheese replicas ranging from spreads to feta-type salad cheese and ripened hard and semi-hard cheese replicas.

The present disclosure concerns a process for producing a non-dairy protein gel, wherein the process comprises the steps of
a. mixing water and at least one non-dairy based raw material containing non-dairy protein to obtain an aqueous protein suspension,
b. homogenizing said aqueous protein suspension to obtain a homogenized aqueous protein suspension,
c. subjecting said homogenized aqueous protein suspension to heat treatment at a temperature of about 60° C. to about 160° C. for about 1 second to about 5 minutes to obtain a heat-treated protein suspension,
d. acidifying the heat-treated protein suspension to obtain an acidified protein suspension,
e. modifying the acidified protein suspension at a temperature of about 5° C. to about 120° C., to obtain a non-dairy protein gel,
f. solidifying the non-dairy protein gel at a temperature of about 5° C. to about 45°° C., for 8 to 12 hours to obtain a solidified non-dairy protein gel.

The present invention also relates to a non-dairy protein gel obtainable with the process of the invention.

In addition, the present invention concerns a non-dairy protein gel.

The present invention also concerns a use of non-dairy protein gel obtainable with the process according to the present disclosure in a non-dairy cheese.

The present invention also concerns a non-dairy cheese comprising the non-dairy protein gel according to the present disclosure.

### BRIEF DESCRIPTION OF THE DRAWINGS

FIG. 1 illustrates a process for producing a non-dairy cheese replica.

FIG. 2 illustrates a process for producing a non-dairy cheese replica according to Example 1. During heating and homogenisation fat, sugar (sucrose), salt (sodium chloride) and water are added. During fermenting step starter culture and ascorbic acid are added. Gelling is carried our using transglutaminase. After pressing cheese replicas are salted by brine or dry salting.

FIG. 3 illustrates a process for producing a non-dairy cheese replica according to Example 3.

FIG. 4 illustrates pressed and ripened semi-hard cheese replicas.

FIG. 5 illustrates pressed and ripened semi-hard cheese replica.

FIG. 6 illustrates low fat salad cheese replica produced by cutting and pressing the curd.

FIG. 7 illustrates diced low-fat salad cheese replica produced without cutting the curd.

FIGS. 8 illustrates a): pouring of cheese mass into mold; b): hardened cheese mass; c): final, sliceable and elastic product.

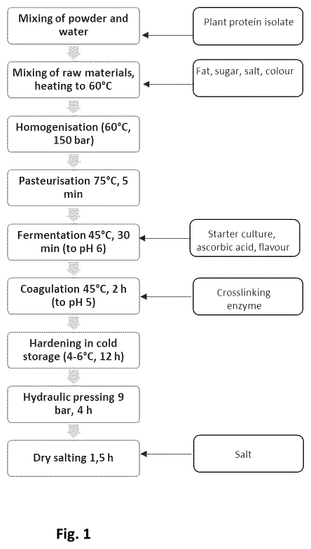

### DEFINITIONS

In the present description and claims, the following words and expressions have meanings as defined below:

A “non-dairy protein” or “dairy-free protein” is selected from the group consisting of plant proteins, insect proteins, algal proteins, microbial proteins such as bacterial, fungal, and yeast proteins, as well as recombinantly produced proteins or protein produce using a recombinant strain.

A “high-protein ingredient” refers to a protein rich ingredient that has a protein content greater than about 70% protein/dry matter. Preferably the high-protein ingredient is an isolate with a protein content in excess of about 90% protein/dry matter, preferably at least about 100% protein/dry matter, (N×6.25).

The terms “protein isolate” and “protein concentrate” differ in terms of protein quantity. These differences are caused by the processing methods. “Protein concentrate” powder consists of up to 80% protein by weight. The remaining 20% of the concentrate powder contains carbohydrates and fats. If different processing steps are used to reduce the fat and carbohydrate content, a “protein isolate” powder containing 90% or more protein by weight can be produced. Overall, the processing steps used in the production of isolate result in higher protein content and lower fat and carbohydrate content. However, the types of amino acids found in both forms of whey are virtually identical, since they are derived from the same proteins.

A “starter culture” is a microbiological culture, which performs fermentation. The starters usually consist of a cultivation medium, such as nutrient liquids that have been well colonized by the microorganisms used for the fermentation.

A “plant-based food product” may refer to fermented, acidified or non-acidic (neutral) food products, such as traditional dairy-based products like yoghurt, drinkable yoghurt, crème fraiche or sour cream, sour milk, quark, cream cheese (Philadelphia-type soft cheese), set-type yoghurt, smoothie or pudding. In the present disclosure “plant-based food product” is especially selected from the group consisting selection of cheese replicas ranging from spreads to feta-type salad cheese and ripened hard and semi-hard cheese replicas.

“Plant-based” refers to originating from plants, which are suitable for manufacturing edible food products in food technology applications. The plant-based raw material suitable for the product and process of the present invention may be from at least one plant selected from leguminous plants, such as dry and fresh beans, soybeans, dry and fresh peas, lentils, chickpeas and peanuts, more preferably selected from broad bean and pea, most preferably from broad bean.

A “legume” or leguminous plant” refers to a plant belonging to the family Fabaceae (or Leguminosae), which family is commonly known as the legume, pea, or bean family. Said family is a large family of flowering plants. A legume also refers to the fruit or seed of a leguminous plant. The seed is also called a pulse. Legumes include for example alfaalfa (Medicago sativa), clovers (Trifolium spp.), peas (Pisum), beans (Phaseolus spp., Vigna spp., Vicia spp.), chickpeas (Cicer), lentils (Lens), lupins (Lupinus spp.), mesquites (Propsis spp.), carob (Ceratonia siliqua), soybeans (Glycine max), peanuts (Arachis hypogaea), vetches (Vicia), tamarind (Tamarindus indica), kudzu (Pueraria spp.) and rooibos (Aspalathus linearis). Legumes produce a botanically unique type of fruit—a simple dry fruit that develops from a simple carpel and usually dehisces (opens along a seam) on two sides.

### DETAILED DESCRIPTION OF THE INVENTION

The present disclosure describes a method for producing an acidified non-animal protein-based gel that can be used as such as cheese alternative or spread, or processed further into a pressed, hard cheese replica. The gel is produced by reconstituting one or more protein raw material(s) with (60-95% protein) in water. In addition to protein, other compounds such as fat and polysaccharides can be added to modify the texture and water retention properties of the resulting gel. Other ingredients include one or more sugar or other fermentable carbohydrate, flavouring, colouring, nutritional fortification, preservative, antioxidant and salt.

The present disclosure concerns a process for producing a non-dairy protein gel, wherein the process comprises the steps of
a. mixing water and at least one non-dairy based raw material containing non-dairy protein to obtain an aqueous protein suspension,
b. homogenizing said aqueous protein suspension to obtain a homogenized aqueous protein suspension,
c. subjecting said homogenized aqueous protein suspension to heat treatment at a temperature of about 60° C. to about 160° C. for about 1 second to about 5 minutes to obtain a heat-treated protein suspension,
d. acidifying the heat-treated protein suspension to obtain an acidified protein suspension,
e. modifying the acidified protein suspension at a temperature of about 5° C. to about 120° C., to obtain a non-dairy protein gel,
f. solidifying the non-dairy protein gel at a temperature of about 5° C. to about 45° C., for 8 to 12 hours to obtain a solidified non-dairy protein gel.

The above-mentioned steps a. to f. may be performed in succession.

According to an embodiment, the non-dairy protein is a protein isolate or a protein concentrate.

Further, according to an embodiment the non-dairy protein is selected from the group consisting of plant proteins, insect proteins, algal proteins, microbial proteins such as bacterial, fungal, and yeast proteins, and recombinantly produced proteins and proteins produced using a recombinant strain.

In an embodiment, the non-dairy protein is a plant protein, preferably a leguminous protein, preferably the leguminous protein is selected from broad bean and pea.

According to an embodiment, the non-dairy protein is a plant protein, preferably a leguminous protein, preferably the leguminous protein is selected from broad bean and pea. The plant-based raw material suitable for the product and process of the present invention may be from at least one plant selected from leguminous plants, such as dry and fresh beans, soybeans, dry and fresh peas, lentils, chickpeas and peanuts, more preferably selected from broad bean and pea, most preferably from broad bean.

In an embodiment, the protein is in powder form.

In an embodiment the aqueous protein suspension obtained in step a. is heated to a temperature between 40° C. and 80° C., preferably to a temperature between 50° C. and 70° C., more to a temperature between 55° C. and 65° C., most preferably to a temperature of 60° C. The temperature depends on the melting temperature of fat or oil contained in the non-dairy plant material.

In an embodiment, in step b. one or more further ingredients selected from the group consisting of fat, polysaccharides, sugars or other fermentable carbohydrates, flavourings, colourings, fortification ingredients, preservatives, antioxidants and salt are added.

In an embodiment the antioxidant is used in an amount of about 0.001-1.0 wt %, preferably about 0.01-0.25 wt %, more preferably 0.1 wt % of an antioxidant, such as ascorbic acid. The amount of the antioxidant may be such as 0.001, 0.005, 0.01, 0.02, 0.03, 0.04, 0.05, 0.06. 0.07, 0.08, 0.09, 0.1, 0.2, 0.3, 0.4, 0.5, 0.6, 0.7, 0.8, 0.9, or 1.0 wt %.

The antioxidant and/or an ingredient with antioxidative properties may be selected from the group consisting of ascorbic acid, salts of ascorbic acid such as sodium ascorbate and calcium ascorbate, polyphenolic antioxidants, sulphites, bisulphites, fatty acid esters of ascorbic acid, tocopherols, tocotrienols, polyphenol antioxidants, polyphenol antioxidant containing plant extracts, eugenol, butylated hydroxyanisole, butylated hydroxytoluene, propyl gallate, erythorbic acid, salts of erythorbic acid, e.g. sodium erythorbate, extracts of rosemary, tertiary-butyl hyroquinole, butylated hydroxyanisone, butylated hydroxytoluene, and 4-hexylresorcinol.

In an embodiment, the fermentable carbohydrates are selected from the group consisting of added carbohydrates, endogenous carbohydrates, carbohydrates formed by hydrolysis of raw material, including glucose, sucrose, fructose, maltose, maltotriose, raffinose, stachyose, verbascose, kestoses, galactose, melibiose, cellobiose, ribose, turanose, xylose, rhamnose, arabinose, trehalose, inuline, inositol.

In an embodiment, the fat is selected from the group consisting of fats derived from plants such as canola, coconut, shea, and sunflower seed, fats derived from algae, fats derived from microbial sources, and fats produced using a recombinant strain.

In an embodiment the polysaccharide is selected from the group consisting of any gelling or otherwise texture forming polysaccharide from plants, algae or microbes, such as gellan, agar, carrageenan, pectin, xanthan, and starch.

In an embodiment the homogenization in step b. is carried out a temperature between 40° C. and 80° C., preferably to a temperature between 50° C. and 70° C., more to a temperature between 55° C. and 65° C., most preferably to a temperature of 60° C.

In an embodiment the homogenization in step b. is carried out at pressure of 100 to 400 bar, preferably at pressure of 125 to 300 bar, more preferably at a pressure of 150 bar. The pressure may be 100, 125, 150, 200, 250, 300, 350, or 400 bar, or in the range defined by any two of these values.

In an embodiment, the homogenized aqueous protein suspension is subjected to heat treatment at a temperature of about 60° C. to about 160° C. for about 1 second to about 5 minutes to obtain a heat-treated protein suspension.

In an embodiment, the heat treatment in step c. is carried out at a temperature from about 75° C. to about 105°° C., preferably from about 60° C. to about 78° C., preferably at a temperature of 75° C., for about 30 seconds to 30 minutes, preferably for about 30 seconds to 5 minutes, more preferably for 5 minutes to obtain a heat-treated suspension. The higher the temperature is, the shorter the required time for heat treatment is. For example, if the temperature of the heat treatment is 160° C., the required treatment time is only 1 to 5 seconds. If the treatment temperature is low such as 30° C., the time may be 60 minutes. Heat treatment step may be pasteurization, which may be carried out at a temperature of about 75° C. to about 105° C. for about 30 seconds to about 5 minutes, preferably the pasteurization is carried out at a temperature of about 75° C. for about 30 seconds to about 5 minutes, preferably for about 5 minutes.

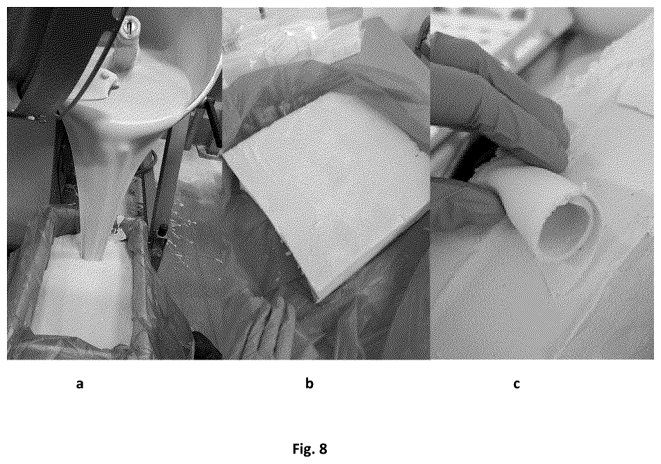

The heat treatment step i.e. pasteurization is carried out for hygiene reasons. The heat-treated suspension looks like in FIG. 8a.

It is possible to carry out the heat treatment heat treatment at a temperature of about 60° C. to about 160° C. for about 1 second to about 60 minutes to obtain a heat-treated protein suspension. The heat treatment may be carried out at a temperature of 60, 65, 70, 75, 80, 90, 100, 110, 120, 130, 140, 150, or 160° C., or in the range defined by any two of these values. The heat treatment may be carried out for 30 seconds, or 1, 2, 3, 4, 5, 6, 7, 8, 9, 10, 15, 20, 25, or 30, 35, 40, 45, 55, or 60 minutes, or in the range defined by any two of these values.

In an embodiment, in step d. the acidification is carried out microbiologically or chemically.

In an embodiment, in step d. acidification is carried out by adding starter culture to the heat treated protein suspension and incubating at a temperature from 30° C. to 50° C., more preferably at a temperature from 35° C. to 45° C., preferably at a temperature of 45° C., for 15 minutes to 1 hour, preferably for 30 minutes, at a pH from pH 4 to pH 7, preferably at pH of pH 6 to pH 6.5.

The acidification may be carried out at a temperature of 30, 31, 32, 33, 34, 35, 36, 37, 38, 39, 40, 41, 42, 43, 44, 45, 46, 47, 48, 49, or 50° C., or in the range defined by any two of these values. The acidification may be carried out at a pH of pH 4, 4.5, 5, 5.5, 6, 6.5, or 7, or in the range defined by any two of these values.

In an embodiment, in step d. ascorbic acid, and optionally flavor is added.

In an embodiment, in step e. the modification is carried at a temperature from 30°° C. to 50° C., preferably at a temperature from 35° C. to 45° C., more preferably at a temperature of 45° C., and the acidified protein suspension is subjected to one or more modifications selected from the group consisting of an enzymatic treatment, heat treatment, flavor modification, colour modification, and treatment with gelling polysaccharide(s), enzymatically using cross-linking enzyme(s), by acid, salt and polysaccharide assisted gelation, by acidifying past the gelation point of the chosen protein, and/or by adding protons (acid, salt), preferably the modification is enzymatic treatment.

Preferably modification of the acidified protein suspension is carried out enzymatically using cross-linking enzyme(s), by acid, salt and polysaccharide assisted gelation, by acidifying past the gelation point of the chosen protein, and/or by adding protons (acid, salt). More preferably the modification is enzymatic treatment.

In an embodiment, the enzymatic treatment is carried out with a cross-linking enzyme selected from the group consisting of transglutaminase, tyrosinase, catechol oxidase and laccase, preferably the cross-linking enzyme is transglutaminase.

In an embodiment, the modification in step e. is carried at a temperature from 30°° C. to 50° C., and the acidified protein suspension is subjected to an enzymatic treatment using cross-linking enzyme(s) selected from the group consisting of transglutaminase, tyrosinase, catechol oxidase and laccase, preferably the cross-linking enzyme is transglutaminase.

In an embodiment, the modification in step e. is carried at a temperature from 30°° C. to 50° C., and the acidified protein suspension is subjected to an enzymatic treatment with transglutaminase.

The enzymatic treatment may be carried out at a temperature of 30, 31, 32, 33, 34, 35, 36, 37, 38, 39, 40, 41, 42, 43, 44, 45, 46, 47, 48, 49, or 50°° C., or in the range defined by any two of these values.

In an embodiment the amount of cross-linking enzyme is about 0.01-1.0 wt %, preferably 0.05-0.8 wt %, more preferably 0.01-0.5 wt %, most preferably 0.5 wt % of cross-linking enzyme. The amount of cross-linking enzyme may be 0.01, 0.05, 0.1, 0.2, 0.3, 0.4, 0.5, 0.6, 0.7, 0.8, 0.9, or 1.0 wt %, or in the range defined by any two of these values.

In an embodiment, the protein suspension is coagulated for about 2 hours at pH 4.5-5.9.

In an embodiment, solidification of the non-dairy protein gel in step f. is carried out at a temperature of about 4° C. to about 6° C., for 12 hours to obtain a solidified non-dairy protein gel.

In an embodiment, after step f. the solidified non-dairy protein gel is subjected to one or more further treatments selected from the group consisting of: pressing for less than 24 hours, preferably 4-6 h, at 5-12 bar, preferably at 9 bar; salting; or cutting into particles of size 2 to 15 mm and thereafter pressing.

In an embodiment the pressing of the solidified non-dairy gel is carried out for 23, 22, 21, 20, 19, 18, 17, 16, 15, 14, 13, 12, 11, 10, 9, 8, 7, 6, 5, or 4 hours, or in the range defined by any two of these values. The pressing of the solidified non-dairy gel may be carried out at 5, 6, 7, 8, 9, 10, 11, or 12 bar, or in the range defined by any two of these values. The solidified non-dairy gel may be cut into particles of 2, 3, 4, 5, 6, 7, 8, 9, 10, 11, 12, 13, 14, or 15 mm, or into the range defined by any two of these values

In an embodiment the present disclosure concerns a process for producing a non-dairy protein gel, wherein the process comprises the steps of
a. mixing water and at least one non-dairy based raw material containing non-dairy protein to obtain an aqueous protein suspension,
b. homogenizing said aqueous protein suspension to obtain a homogenized aqueous protein suspension,
c. subjecting said homogenized aqueous protein suspension to heat treatment at a temperature of about 60° C. to about 160° C. for about 1 second to about 5 minutes to obtain a heat-treated protein suspension,
d. acidifying the heat-treated protein suspension to obtain an acidified protein suspension,
e. modifying the acidified protein suspension by enzymatic treatment at a temperature of about 30° C. to about 50° C., to obtain a non-dairy protein gel,
f. solidifying the non-dairy protein gel at a temperature of about 5° C. to about 45° C., for 8 to 12 hours to obtain a solidified non-dairy protein gel.

In an embodiment the present disclosure concerns a process for producing a non-dairy protein gel, wherein the process comprises the steps of
a. mixing water and at least one non-dairy based raw material containing non-dairy protein to obtain an aqueous protein suspension,
b. homogenizing said aqueous protein suspension to obtain a homogenized aqueous protein suspension,
c. subjecting said homogenized aqueous protein suspension to heat treatment at a temperature of about 60° C. to about 160° C. for about 1 second to about 5 minutes to obtain a heat-treated protein suspension,
d. acidifying the heat-treated protein suspension to obtain an acidified protein suspension,
e. modifying the acidified protein suspension by enzymatic treatment with a cross-linking enzyme selected from the group consisting of transglutaminase, tyrosinase, catechol oxidase and laccase at a temperature of about 30° C. to about 50° C. to obtain a non-dairy protein gel,
f. solidifying the non-dairy protein gel at a temperature of about 5° C. to about 45°° C., for 8 to 12 hours to obtain a solidified non-dairy protein gel.

In an embodiment the present disclosure concerns a process for producing a non-dairy protein gel, wherein the process comprises the steps of
a. mixing water and at least one non-dairy based raw material containing non-dairy protein to obtain an aqueous protein suspension,
b. homogenizing said aqueous protein suspension to obtain a homogenized aqueous protein suspension,
c. subjecting said homogenized aqueous protein suspension to heat treatment at a temperature of about 60° C. to about 160° C. for about 1 second to about 5 minutes to obtain a heat-treated protein suspension,
d. acidifying the heat-treated protein suspension to obtain an acidified protein suspension,
e. modifying the acidified protein suspension by enzymatic treatment with transglutaminase at a temperature of about 30° C. to about 50° C. to obtain a non-dairy protein gel,
f. solidifying the non-dairy protein gel at a temperature of about 5° C. to about 45° C., for 8 to 12 hours to obtain a solidified non-dairy protein gel.

In an embodiment the present disclosure concerns a process for producing a non-dairy protein gel, wherein the process comprises the steps of
a. mixing water and plant protein isolate to obtain an aqueous protein suspension,
b. homogenizing said aqueous protein suspension to obtain a homogenized aqueous protein suspension,
c. subjecting said homogenized aqueous protein suspension to heat treatment at a temperature of about 75° C. to about 105° C. for about 30 seconds to about 5 minutes to obtain a heat-treated protein suspension,
d. acidifying the heat-treated protein suspension to obtain an acidified protein suspension,
e. modifying the acidified protein suspension by enzymatic treatment with transglutaminase at a temperature of about 30° C. to about 50° C. to obtain a non-dairy protein gel,
f. solidifying the non-dairy protein gel at a temperature of about 5° C. to about 45°° C., for 8 to 12 hours to obtain a solidified non-dairy protein gel.

In a preferred embodiment of the present disclosure plant protein isolate, fat, water, colour, flavoring and sugar are mixed in a cooking mixer until homogenous to obtain an aqueous protein suspension. The aqueous protein suspension is homogenised and pasteurised by heating under high shear to 75-95° C. for 1-10 minutes. The mass is cooled to 30-50° C. Then, the mass (heat-treated protein suspension) is acidified by using a microbial starter or glucono-delta-lactone or both. When pH has reached pH 5.0-5.7, a cross-linking enzyme is added in the acidified protein suspension. The enzymatically treated mass (non-dairy protein gel) is then transferred in a mold or packaging. The mass is allowed to gel for 3-15 h at room temperature. The pH of the final, gelled product is pH 4.2-4.8. At this pH, some water is expelled spontaneously from the product. This increases the solids content of the mass to 35-45%. The product can be cut into blocks, slices, cubes or sticks.

Further, the present disclosure concerns a non-dairy protein gel obtainable with the process according to the present specification.

The present disclosure also concerns a non-dairy cheese obtainable with the process according to the present disclosure.

In an embodiment a non-dairy cheese comprises about 5-30 wt %, preferably about 6-25 wt %, more preferably about 10-20 wt %, most preferably 12-18 wt %, even most preferably 14 wt % of vegetable protein, about 5-30 wt %, preferably about 10-20 wt %, more preferably about 15 wt % of vegetable fat, and about 40-70 wt %, preferably about 50-66 wt %, preferably about 50-60 wt %, more preferably 53-57 wt % of water.

In an embodiment a non-dairy cheese further comprises ingredients selected from the group consisting of about 1-5 wt %, preferably 2-4 wt %, more preferably 3 wt % of sugar, about 0.0-2.0 wt %, preferably 0.5 wt % of salt, about 0.001-1.0 wt %, preferably 0.01-0.25 wt %, more preferably 0.1 wt % of antioxidant, about 0.05-1.0 wt %, preferably 0.08-0.5 wt %, more preferably 0.1 wt % of starter culture, and about 0.01-1.0 wt %, preferably 0.05-0.8 wt %, more preferably 0.01-0.5 wt %, 0.5 wt % of cross-linking enzyme, about 0.1-0.5 wt %, preferably 0.2 wt % of flavorings, and about 0.5-2.0 wt %, preferably 1.5 wt % of food colourings.

In an embodiment a non-dairy cheese comprises 14 wt % of non-dairy protein, 65.1 wt % of water, 15 wt % of vegetable fat, 3 wt % of sugar, 0.5 wt % of salt, 0.1 wt % of ascorbic acid, 0.1 wt % of starter culture, 0.5 wt % of cross-linking enzyme, 0.2 wt % of flavor, and 1.5 wt % of food colour.

In an embodiment a non-dairy cheese comprises 14 wt % of non-dairy protein, 56.1 wt % of water, 15 wt % of vegetable fat, 3 wt % of sugar, 0.5 wt % of salt, 0.1 wt % of ascorbic acid, 0.1 wt % of starter culture, 0.5 wt % of cross-linking enzyme, 0.2 wt % of flavor, and 1.5 wt % of food colour.

In an embodiment a non-dairy based cheese comprises 14 wt % of non-dairy protein, 63 wt % of water, 20 wt % of vegetable fat, 1.0 wt % of sugar, 1.0 wt % of glucono-delta-lactone, 0.1 wt % of starter culture, 0.5 wt % of cross-linking enzyme, 0.3 wt % of flavor, and 0.1 wt % of food colour.

The non-dairy cheese prepared using the non-dairy protein gel according to the present disclosure may have the following characteristics: hardness of 5 000-40 000 g (gram), preferably 20 000-30 000 g, more preferably 26 000 g, springiness of 0.3-0.9, preferably 0.6-0.8, more preferably 0.8, and gumminess of 2000-14 000, preferably 8 000-12 000, more preferably 11 785.

In an embodiment the non-dairy cheese prepared using the non-dairy protein gel according to the present disclosure may have the following characteristics: hardness of 20 000-30 000 g, preferably 26 000 g, springiness of 0.6-0.8, preferably 0.8, and gumminess of 8 000-12 000, preferably 11 785.

The hardness may be such as 5 000 g, 10 000 g, 15 000 g, 20 000 g, 21 000 g, 22 000 g, 23 000 g, 24 000 g, 25 000 g, 26 000 g, 27 000 g, 28 000 g, 29 000 g, 30 000 g, 31 000 g, 32 000 g, 33 000 g, 34 000 g, 35 000 g, 36 000 g, 37 000 g, 38 000 g, 39 000 g, or 40 000 g, or in the range defined by any two of these values.

The springiness may be such as 0.3, 0.4, 0.5, 0.6, 0.7, 0.8, or 0.9, or in the range defined by any two of these values.

The gumminess may be such as 2 000, 3 000, 4 000, 5 000, 6 000, 7 000, 8 000, 9 000, 10 000, 11 000, or 12, 000, or in the range defined by any two of these values.

Springiness and gumminess are computational parameters and relative measures.

In an embodiment the cheese is semi-hard cheese, semi-soft cheese, or cream cheese.

The mass may be pasteurised (62-160° C. for 1s to 60 min, more preferably 75-105° C. for 30 s-5 min) and homogenised using e.g. pasteuriser, homogeniser, high shear mixer, mixing tank or cooking mixer. After pasteurisation, the mass maybe acidified microbiologically or chemically. The mass can additionally be treated with enzymes to hydrolyse interfering components in raw materials or to modify colour and flavour. The mass can be modified for gel formation by acidifying the mass past the gelation point of the chosen protein and cured by protons (acid) or other ions (salts). Ionic strength strongly influences gelling properties of the mass and its level can be used to optimise resulting textures. The mass can also be modified by curing enzymatically by adding a crosslinking enzyme, preferably protein cross-linking enzyme, when the acidified mass has reached a pH of 5.8-6.8. Alternatively or additionally, enzymatic curing can be performed for protein raw material, dissolved in water, before other compounds are mixed in. Also, alternatively or additionally, the enzyme cured mass can be concentrated after curing to influence the structural properties of the produced gel. Alternatively, or additionally, the acidified mass can be modified by heating to 80-121° C. for gelation. Alternatively, fermented mass can be cured with gelling polysaccharides.

Fermentation temperature is selected based on the properties of starter microbe(s) but is generally 30-45° C.

Mass is then allowed to solidify. The temperature depends on method of gelling: 5-30° C. in the case of acid and polysaccharide-assisted gelation and 5-45° C. in the case of enzymatically cross-linked gel. The temperature can also be decreased stepwise within these ranges during solidification step.

After solidification, the product can be salted in brine or by dry-salting and packed. Alternatively, the product can be pressed to remove whey and increase dry matter content and hardness. Alternatively, the product can be cut into particles sizes of 2-30 mm, depending on the desired cheese type, and pressed similarly to dairy cheese. A cross-linking enzyme can be added at this point to bind the particles together during pressing.

Non-dairy protein can be plant protein (e.g. from seeds of legumes or cereals, tubers or other plant tissue), algal protein, microbial protein (e.g. bacterial, fungal, yeast). The protein can be produced using a recombinant strain.

For fermentation, any starter capable of growing in the mass can be used, including strains from Lactococcus sp, Leuconostoc sp Lactobacillus sp, Streptococcus sp, Bifidobacterium sp, Staphylococcus sp, Pediococcus sp, Propionibacterium sp, Acidipropionibacterium sp, Brevibacterium sp, Corynebacterium sp, Penicillium sp, Geotrichum sp, Saccharomyces sp, Debaromyces sp, Arthrobacter sp, Microbacterium sp, Kluyveromyces sp or other bacteria useful in acidification or fermentation.

Fermentable carbohydrates can be exogenous, endogenous or formed by hydrolysis of raw material. Fermentable carbohydrates include glucose, sucrose, fructose, maltose, maltotriose, raffinose, stachyose, verbascose, kestoses, galactose, melibiose, cellobiose, ribose, turanose, xylose, rhamnose, arabinose, trehalose, inuline, and inositol.

The fat can be one fat or a blend that has desired textural and melting properties. The fat can be derived from plants (e.g. canola, coconut, shea, sunflower seed), algae or microbial sources. The fat can be produced using a recombinant strain.

Polysaccharides can be any gelling or otherwise texture forming polysaccharides from plants, algae or microbes (e.g. gellan, agar, carrageenan, pectin, xanthan, starch).

To combat off-flavours typical for plant proteins, a combination of microbial fermentation, antioxidant and flushing unwanted flavour compounds out of the product during whey drainage are used. The combination of these methods results in a mildly flavoured product with light colour.

The non-dairy cheese of our invention has high protein content and is produced from purified pulse protein isolate.

Pulse protein used in the present process is fava bean protein, but it could also be any other pulse protein from beans, peas, chickpeas or lentils.

The fat used in the recipe of the present process is a mixture of coconut oil and shea butter, but it could also be any other mixture of vegetable oils with similar triglyceride content mimicking the functionality of dairy fat. The sugar used in our recipe is saccharose, but it could also be any other mono-or disaccharide that the starter culture bacteria are able to ferment.

Ascorbic acid in the recipe is used as an antioxidant and it ensures the bright colour of the end product.

Protein can be cross-linked by any method capable of forming covalently or non-covalently cross-linked gel structures incl. enzymatic, chemical, acid-or heat-induced cross-linking.

The texture of a product, such as cheese, can be measured by TA.XT texture analyzer, performing a compression test. A compression test is the most simple and popular test of instrumental texture measurement. A sample is placed on a flat surface and a flat platen is lowered onto the sample to a given force or distance. Sample is deformed and the extent of the deformation and/or the resistance offered by the sample is recorded. Hardness, springiness (elasticity) and gumminess are measured.

Hardness is the force required to compress a cheese between the molar teeth or between the tongue and palate to a given deformation or to the point of penetration. The hardness value is the peak force that occurs during the first compression, i.e. it is expressed as the maximum force of the first compression. The hardness need not occur at the point of deepest compression, although it typically does for most products.

Springiness (elasticity) is the degree of recovery of a deformed piece of cheese after the deforming force is removed. Springiness is how well a product physically springs back after it has been deformed during the first compression and has been allowed to wait for the target wait time between strokes. The springback is measured at the downstroke of the second compression. In some cases, an excessively long wait time will allow a product to springback more than it might under the conditions being researched (e.g. you would not wait 60 seconds between chews). Springiness is expressed as a ratio or percentage of a product's original height. Springiness is measured several ways, but most typically, by the distance of the detected height during the second compression divided by the original compression distance.

Gumminess is denseness that persists through mastication, energy required to disintegrate a piece of cheese to a state ready for swallowing. Gumminess is mutually exclusive with chewiness since a product would not be both a semi-solid and a solid at the same time.

Protein content may bes analyzed using the method ISO 8968-1, IDF 20-1:2014; fat content by method ISO 1735, IDF 5:2004 and dry matter content by ISO 6731, IDF 21:2010. The carbohydrate content is calculated based on the fat, protein and dry matter content.

The present invention is further illustrated with the following examples.

### EXAMPLES

### Example 1

### Semi-Hard, Ripened Cheese Replica

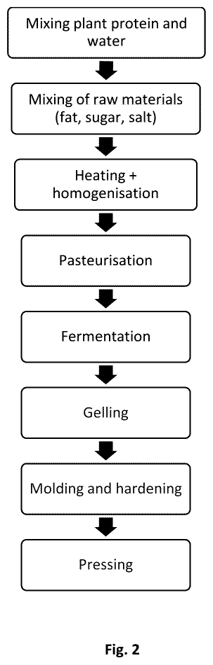

A recipe and process for producing a protein based non-dairy cheese was developed, that has a texture similar to semi-hard dairy cheeses. The recipe for producing a protein based non-dairy cheese of the present disclosure is presented in Table 1. The process is illustrated in FIG. 2.

TABLE 1
Ingredients of protein based non-dairy cheese

| RECIPE | wt % |
|---|---|
| Plant protein isolate | 14 |
| Water | 65.1 |
| Vegetable fat | 15 |
| Sugar | 3 |
| Salt | 0.5 |
| Ascorbic acid | 0.1 |
| Starter culture | 0.1 |
| Cross-linking enzyme | 0.5 |
| Flavour | 0.2 |
| Food colour | 1.5 |
| TOTAL | 100 |

The process for producing a non-dairy cheese replica was as follows: The fava bean protein isolate was mixed with water, other raw materials: fat, sugar (sucrose), salt (sodium chloride) and food colour were added, the mixture was heated to 60° C. and homogenized at 150 bar.

The homogenized mixture was further pasteurized at 75° C., for 5 min and cooled to incubation temperature (45° C.). The starter culture, ascorbic acid and flavor were added, and the mixture was fermented ca 30 min to pH 5.8-6.8. After that, to modify the acidified suspension into gel, cross-linking enzyme (Ajinomoto, transglutaminase) was added, the mixture was poured to coagulation molds and the mixture was coagulated for 2 hours to pH 4.5-5.9. The gelled mass was further hardened in cold store (4-6° C.) for 12 hours. The cheese mass was then moved to pressing molds and the excess whey was pressed out by a hydraulic press (9 bar 4-6 hours). After pressing the cheese replicas were salted in brine or by dry salting.

The texture of a non-dairy cheese replica produced by our process resembled semi-hard dairy cheese as presented in Table 2.

TABLE 2
Texture analysis of cheeses

| Cheese | Hardness | Springiness | Gumminess |
|---|---|---|---|
| Valio Oltermanni (semi-hard | 28113 | 0.7 | 12000 |
| cheese, 29% fat) | | | |
| Non-dairy cheese of the present | 26000 | 0.8 | 11785 |
| disclosure (25% fat) | | | |

The texture of cheese was measured by TA.XT texture analyzer, performing a compression test. A compression test is the most simple and popular test of instrumental texture measurement. A sample was placed on a flat surface and a flat platen was lowered onto the sample to a given force or distance. Sample was deformed and the extent of the deformation and/or the resistance offered by the sample is recorded.

The analysis we used was TPA75 (texture profile analysis, irreversible method, 75%). The probe is P75, the product analyzed was compressed 75% of its initial height in 2 stages.

By adding food color and flavor, also the appearance and taste were similar to dairy cheese.

The chemical composition of the present non-dairy cheese compared to an average starch based non-dairy cheese is presented in Table 3.

TABLE 3
Nutritional composition of non-dairy cheeses: plant protein-based
cheese replica, starch-based cheese replica and dairy cheese.

| | | | | Dry |
|---|---|---|---|---|
| Cheese | Protein | Fat | Carbohydrates | matter |
| Protein-based non-dairy | 20% | 25% | 3% | 48% |
| cheese (present disclosure) | | | | |
| Starch-based non-dairy cheese | 1% | 21% | 18% | 40% |
| (Valio Veggie) | | | | |
| Dairy cheese (Valio | 25% | 29% | 0% | |
| Oltermanni) | | | | |

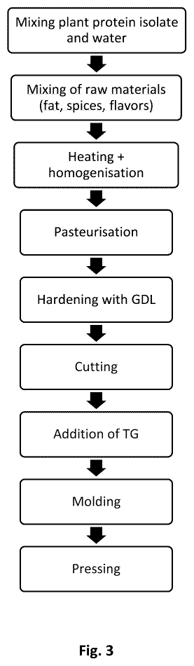

Pressed and ripened semi-hard cheese replicas are presented in FIGS. 2 and 3.

### Example 2

Plant-Based Cheese with High Solids Content

Pea protein isolate (commercial Profam 580), vegetable fat (mixture of coconut oil and shea oil), water, colouring agent, flavoring agents and sugar were mixed in a cooking mixer (Stephan Cooker) at 50° C.-60° C. until homogenous. The mass was pasteurised and homogenised by heating under high shear to 75° C.-95° C. for 1-10 minutes (in Stephan Cooker). The mass was cooled to 30° C.-50° C. Then, the mass was acidified using a microbial starter (Flora 1060, Lactococcus lactis subsp. cremoris, Lactococcus lactis subsp. lactis, Lactococcus lactis subsp. lactis biovar, Diacetylactis Leuconostoc) and glucono-delta-lactone. When pH 5.0-5.7 was reached, a cross-linking enzyme transglutaminase (Ajinomoto) was added in the mass. The mass was then poured in a mold. The viscosity of the mass was about 1000 cP. The mass was allowed to gel in the mold for 3-15 h at room temperature. The pH of the final, gelled product was pH 4.4-4.6. At this pH, some liquid was expelled spontaneously from the product. The mass was not pressed. This increased the total solids content of the mass to 42.5%. The product can be cut into blocks, slices, cubes or sticks. The vegan cheese product is elastic and it can be cut into slices and it does not break when rolled to a shape of a roll like milk-based ripened cheese (edam, gouda and other semi-soft cheeses).

TABLE 4
Recipe of Example 2: plant-based cheese with high solids content.

| | % |
|---|---|
| Pea protein isolate | 14.0 |
| Water | 63.0 |
| Vegetable fat mixture, shea butter and coconut oil | 20.0 |
| Colouring agent | 0.1 |
| Flavoring agent | 0.3 |
| Sugar | 1.0 |
| Glucono-delta lactone | 1.0 |
| Starter culture | 0.1 |
| Cross-linking enzyme | 0.5 |

### Example 3

### Low Fat Salad Cheese Replica

Recipe for low fat salad cheese replica is given in Table 5. The process is illustrated in FIG. 3. Plant protein was mixed in water and allowed to hydrate under 10% shear in a cooking mixer. Flavoring, fat and spices were added, and mixture was heated to 60° C. for 10 min under shear to melt and blend the fat. Shear rate was increased to 30% and mixture was heated rapidly to 75° C. for 5 min. Then, shear rate was decreased to 10% and mixture was cooled to 30° C. Glucono delta lactone (GDL) is blended in thoroughly, mixture was poured in a container and allowed to harden at room temperature for 5-10 h. Hardened gel was cut into particles of 2-15 mm. Cross-linking enzyme dispersed in water was blended in the container with curds and the mixture were then poured in a cheese molds for pressing. Molds were placed in a cheese press and pressure was added gradually up to 9 bars. After desired dry matter content was achieved, cheeses were removed from the press and dry salted to desired salt content. Cheeses can be packed as such or cut into slices, sticks or cubes.

TABLE 5
Recipe for low fat salad cheese replica.
RECIPE (MASS)

| | | |
|---|---|---|
| Plant protein flour | 70 | g |
| Water | 900 | g |
| Vegetable fat blend | 20 | g |
| GDL | 5 | g |
| Flavoring | 2.5 | g |
| Spices (optional) | 2.5 | g |

POST PROCESSING

| | | |
|---|---|---|
| Cross-linking enzyme | 5 | g |
| Water | 100 | g |

| | |
|---|---|
| Salt | dry salting |

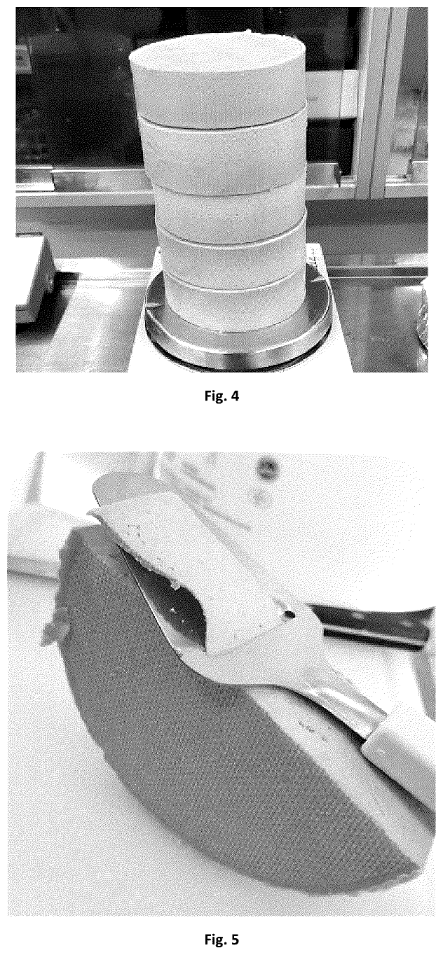

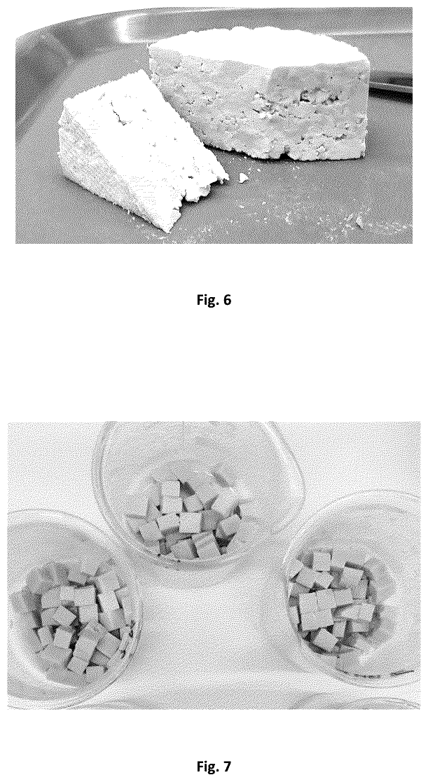

Low fat salad cheese replica produced by cutting and pressing the curd is presented in FIG. 4.

### Example 5

### Plant-Based Cheese

A fava bean protein isolate was prepared as follows: 0.02 wt % sodium sulphite (Na₂SO₃) was solubilized in water with 8 wt % air classified fava bean protein concentrate flour after mixing, 0.1 wt % ascorbic acid was solubilized into the suspension. pH of the suspension was adjusted to pH 7.0 using sodium hydroxide and suspension was then mixed at room temperature for 90 minutes. The suspension was clarified by removal of insoluble solids with a decanter centrifuge and nozzle-bowl separator. The clarified suspension was enzymatically treated by adding 0.1 wt % of a commercial enzyme with known tannase activity (Viscozyme L, Novozymes) and incubated for 30 minutes at room temperature under constant mixing. After this enzyme was inactivated by heat-treatment at 80° C. for 5 minutes. Heat-treated suspension was then concentrated with ultrafiltration using 10 kDa spiral-wound membrane and rinsed with diafiltration. Optionally, subsequently concentrated fava bean protein retentate can be then spray dried to produce dried fava bean protein isolate.

In order to determine structural forming properties of the obtained fava bean protein isolate was tested in a vegan cheese application. The fava bean protein isolate was mixed with water and other raw materials: fat, sugar (saccharose), salt (NaCl) and food colour were added into the mixture. The mixture was heated to 60° C. and homogenized at 150 bar. The mixture was further pasteurized at 75° C., for 5 minutes and cooled down to incubation temperature (45° C.). Then the microbial starter culture, ascorbic acid and flavor were added, and the mixture was fermented about 30 minutes to pH 6.0. After that transglutaminase (Ajinomoto Foods) enzyme was added, the mixture was poured to coagulation molds and the mixture was coagulated for 2 hours to pH 5.0. The mass was further hardened in cold store (4-6° C.) around 12 hours. The cheese mass was then moved to pressing molds and the excess whey was pressed out by a hydraulic press (9 bar 4-6 hours). After pressing the vegan cheeses were dry salted.

### REFERENCES

Everett, D. W. 2007. Microstructure of natural cheeses In: A. Y. Tamime (Ed.), Structure of dairy products, Blackwell Publishing Ltd., Oxford, UK.

Mintel, 2019. What's holding back alternative cheese? Powerpoint presentation by Jane Hurh, April 2019.

Oyeyinka, A. T., Odukoya, J. O. and Adebayo, Y. S., 2019. Nutritional composition and consumer acceptability of cheese analog from soy and cashew nut milk. Journal of Food Processing and Preservation, 43 (12), p.e14285.
EP2731451B1
EP3366144A1
U.S. Pat. No. 20,101,96575 A1
U.S. Pat. No. 20,203,23231 A1
WO2017150973 A1
WO2020089383 A1

1.-36. (canceled)

37. A process for producing a non-dairy protein gel, wherein the process comprises the steps of:
a. mixing water and at least one non-dairy based raw material containing non-dairy protein to obtain an aqueous protein suspension,
b. homogenizing said aqueous protein suspension to obtain a homogenized aqueous protein suspension,
c. subjecting said homogenized aqueous protein suspension to heat treatment at a temperature of about 60°° C. to about 160° C. for about 1 second to about 5 minutes to obtain a heat-treated protein suspension,
d. acidifying the heat-treated protein suspension to obtain an acidified protein suspension,
e. modifying the acidified protein suspension at a temperature of about 5° C. to about 120° C., to obtain a non-dairy protein gel,
f. solidifying the non-dairy protein gel at a temperature of about 5° C. to about 45° C., for 8 to 12 hours to obtain a solidified non-dairy protein gel.

38. The process according to claim 37, wherein the source of the non-dairy protein is a protein isolate or a protein concentrate.

39. The process according to claim 37, wherein the non-dairy protein is selected from the group consisting of plant proteins, insect proteins, algal proteins, microbial proteins such as bacterial, fungal, and yeast proteins, and recombinantly produced proteins and proteins produced using a recombinant strain.

40. The process according to claim 37, wherein the non-dairy protein is a plant protein.

41. The process according to claim 37, wherein the protein is in powder form.

42. The process according to claim 37, wherein the aqueous protein suspension obtained in step a. is heated to a temperature between 40° C. and 80° C.

43. The process according to claim 37, wherein step b. one or more further ingredients selected from the group consisting of fat, polysaccharides, sugars or other fermentable carbohydrates, flavourings, colourings, fortification ingredients, preservatives, antioxidants and salt are added.

44. The process according to claim 43, wherein the fermentable carbohydrates are selected from the group consisting of added carbohydrates, endogenous carbohydrates, carbohydrates formed by hydrolysis of raw material, including glucose, sucrose, fructose, maltose, maltotriose, raffinose, stachyose, verbascose, kestoses, galactose, melibiose, cellobiose, ribose, turanose, xylose, rhamnose, arabinose, trehalose, inuline, and inositol.

45. The process according to claim 43, wherein the fat is selected from the group consisting of fats derived from plants such as canola, coconut, shea, and sunflower seed, fats derived from algae, fats derived from microbial sources, fats produced using a recombinant strain.

46. The process according to claim 43, wherein polysaccharide is selected from the group consisting of any gelling or otherwise texture forming polysaccharide from plants, algae or microbes, such as gellan, agar, carrageenan, pectin, xanthan, or starch.

47. The process according to claim 37, wherein the homogenization in step b. is carried out at a temperature between 40°° C. and 80° C.

48. The process according to claim 37, wherein homogenization in step b. is carried out at pressure of 100 to 400 bar.

49. The process according to claim 37, wherein heat treatment in step c. is carried out at a temperature from about 75°° C. to about 105° C.

50. The process according to claim 37, wherein the heat treatment in step c. is carried out at a temperature from 75° C. to 105° C. from 30 seconds to 5 minutes.

51. The process according to claim 37, wherein step d. the acidification is carried out microbiologically or chemically.

52. The process according to claim 37, wherein in step d. the acidification is carried out by adding starter culture to the heat treated protein suspension and incubating at a temperature from 30°° C. to 50° C.

53. The process according to claim 37, wherein step d. ascorbic acid, and optionally flavor is added.

54. The process according to claim 37, wherein step e. the modification is carried at a temperature from 30° C. to 50° C., and the acidified protein suspension is subjected to one or more modifications selected from the group consisting of an enzymatic treatment, heat treatment, flavor modification, colour modification, treatment with gelling polysaccharide(s), enzymatically using cross-linking enzyme(s), by acid, salt and polysaccharide assisted gelation, by acidifying past the gelation point of the chosen protein, and/or by adding protons (acid, salt).

55. The process according to claim 54, wherein step e. the enzymatic treatment is carried out with a cross-linking enzyme selected from the group consisting of transglutaminase, tyrosinase, catechol oxidase and laccase.

56. The process according to claim 37, wherein step e. the modification is carried at a temperature from 30°° C. to 50° C., and the acidified protein suspension is subjected to an enzymatic treatment using cross-linking enzyme(s) selected from the group consisting of transglutaminase, tyrosinase, catechol oxidase and laccase.

57. The process according to claim 37, wherein step e. the modification is carried at a temperature from 30°° C. to 50° C., and the acidified protein suspension is subjected to an enzymatic treatment with transglutaminase.

58. The process according to claim 37, wherein the amount of cross-linking enzyme is about 0.01-1.0 wt % of cross-linking enzyme.

59. The process according to claim 37, wherein step e. during the enzymatic treatment, the protein suspension is coagulated for 2 hours to pH 4.5-5.9.

60. The process according to claim 37, wherein step f. solidification of the non-dairy protein gel is carried out at a temperature of about 4° C. to about 6°° C., for 12 hours to obtain a solidified non-dairy protein gel.

61. The process according to claim 37, wherein after step f. the solidified non-dairy protein gel is subjected to one or more further treatments selected from the group consisting of
a. pressing for 24 hours,
b. salting, and
c. cutting into particles of size 2 to 15 mm and thereafter pressing.

62. A non-dairy protein gel obtainable with the process according to claim 37.

63. A non-dairy protein gel, wherein it comprises non-dairy protein.

64. Use of non-dairy protein gel in a non-dairy cheese.

65. A non-dairy cheese, wherein the non-dairy cheese comprises about 5-30 wt % of vegetable protein, about 5-30 wt % of vegetable fat, and about 40-70 wt % of water.

66. The non-dairy cheese according to claim 65, wherein the non-dairy cheese further comprises ingredients selected from the group consisting of
about 1-5 wt % sugar,
about 0.0-2.0 wt % of salt,
about 0.001-1.0 wt % of antioxidant,
about 0.05-1.0 wt % of starter culture, and
about 0.01-1.0 wt % of cross-linking enzyme,
about 0.1-0.5 wt % of flavorings, and
about 0.5-2.0 wt % of food colourings.

67. The non-dairy based cheese according to claim 65, wherein it comprises 14 wt % of non-dairy protein, 65.1 wt % of water, 15 wt % of vegetable fat, 3 wt % of sugar, 0.5 wt % of salt, 0.1 wt % of ascorbic acid, 0.1 wt % of starter culture, 0.5 wt % of cross-linking enzyme, 0.2 wt % of flavor, and 1.5 wt % of food colour.

68. The non-dairy based cheese according to claim 65, wherein it comprises 14 wt % of non-dairy protein, 63 wt % of water, 20 wt % of vegetable fat, 1.0 wt % of sugar, 1.0 wt % of glucono-delta-lactone, 0.1 wt % of starter culture, 0.5 wt % of cross-linking enzyme, 0.3 wt % of flavor, and 0.1 wt % of food colour.

69. The non-dairy cheese according to claim 65, wherein it comprises non-dairy protein gel and the hardness of the cheese is 5 000-40 000 g.

70. The non-dairy cheese according to claim 65, wherein the structure of the non-dairy cheese is semi-hard cheese, semi-soft cheese, or cream cheese.

71. The non-dairy based cheese according to claim 65, wherein the non-dairy cheese is cubed, sliced or grated as well as individually packed, on top of bread, as a warm dish, in baking, in salads, as a snack, or for grilling.
